(19) United States
(12) Patent Application Publication
(10) Pub. No.: US 2024/0161330 A1
(43) Pub. Date: May 16, 2024

(54) INFORMATION PROCESSOR AND COMPUTER PROGRAM PRODUCT

(71) Applicant: RUTILEA, Inc., Kyoto (JP)

(72) Inventors: Takafumi YANO, Kyoto (JP); Kyosuke SHIBATA, Kyoto (JP); Shabani FARHAD, Kyoto (JP); Kotaro NOMURA, Kyoto (JP)

(73) Assignee: RUTILEA, Inc., Kyoto (JP)

(21) Appl. No.: 18/302,526

(22) Filed: Apr. 18, 2023

Related U.S. Application Data
(63) Continuation of application No. PCT/JP2022/042289, filed on Nov. 14, 2022.

(51) Int. Cl. G06T 7/70; G06F 3/01; G06V 10/25

(52) U.S. Cl. CPC G06T 7/70; G06F 3/013; G06V 10/25; G06T 2207/20081

(57) ABSTRACT

According to one embodiment, an information processor includes a gaze area registration unit, an object registration unit, a learning unit, a work process registration unit, and an output unit. The gaze area registration unit receives registration of a gaze area. The object registration unit receives registration of an object used in work. The learning unit learns a transition in the presence or absence of the object in the gaze area or a transition in the state of the object according to the progress of the work based on a training image that contains the object. The work process registration unit receives registration of information related to work processes, which are obtained by breaking down the work into elements and defined based on the transition. The output unit outputs a verification result regarding the work processes included in the work captured, which is obtained based on learning in the learning unit.

### CROSS-REFERENCE TO RELATED APPLICATION

This application is a bypass continuation application of international application No. PCT/JP2022/042289 having an international filing date of Nov. 14, 2022 and designating the United States of America; the entire disclosure of which is incorporated herein by reference.

### FIELD

Embodiments described herein relate generally to an information processor and a computer program product.

### BACKGROUND

Patent document 1 discloses an image processing apparatus capable of obtaining a scale for evaluating the similarity between images through machine learning.
Patent Document 1: Japanese Unexamined Patent Publication No. 2022-144486

Meanwhile, Patent Document 1 does not address any method for efficiently verifying work processes, and there is still room for improvement in the conventional technology.

Therefore, in one aspect, the present disclosure is directed to providing an information processor that can efficiently verify work processes.

### BRIEF DESCRIPTION OF THE DRAWINGS

FIG. 1 is a block diagram illustrating the configuration of an information processor according to an embodiment;

FIG. 2 is a diagram illustrating an example of a still image for receiving the registration of a gaze area;

FIG. 3 is a diagram illustrating an example of a registration screen for receiving the registration of an object;

FIG. 4A is a diagram illustrating an example of a ground-truth video;

FIG. 4B is a diagram illustrating another example of a ground-truth video; and

FIG. 5 is a diagram illustrating an example of a flowchart that defines a state transition of a work process.

### DETAILED DESCRIPTION

In general, according to one embodiment, an information processor includes a gaze area registration unit, an object registration unit, a learning unit, a work process registration unit, and an output unit. The gaze area registration unit receives the registration of a gaze area. The object registration unit receives the registration of an object used in work. The learning unit learns a transition in the presence or absence of the object in the gaze area or a transition in the state of the object according to the progress of the work based on a training image that contains the object. The work process registration unit receives the registration of information related to work processes, which are obtained by breaking down the work into elements and defined based on the transition. The output unit outputs a verification result regarding the work processes included in the work captured, which is obtained based on learning in the learning unit.

In some embodiments, the output unit outputs an amount of time required for the work processes as the verification result. In other embodiments, the output unit outputs whether each of the work processes is performed or whether there is an error in the work processes as the verification result. In these embodiments, the work process registration unit may receive the registration of order information indicating the order of the work processes. In this case, the output unit may output, as the verification result, whether the work processes are performed in the order indicated by the order information.

In the following, exemplary embodiments will be described in detail with reference to the accompanying drawings.

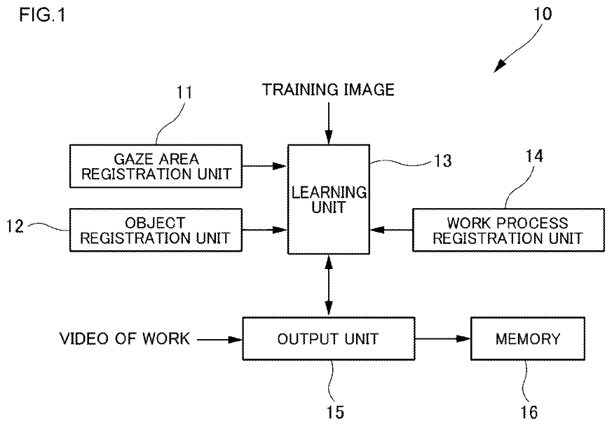

FIG. 1 is a block diagram illustrating the configuration of an information processor 10 according to an embodiment.

As illustrated in FIG. 1, the information processor 10 of this embodiment includes a gaze area registration unit 11, an object registration unit 12, a learning unit 13, a work process registration unit 14, an output unit 15, and a memory 16. The gaze area registration unit 11 receives the registration of a gaze area. The object registration unit 12 receives the registration of an object used in work. The learning unit 13 learns a transition in the presence or absence of the object in the gaze area or a transition in the state of the object according to the progress of the work based on a training image that contains the object. The work process registration unit 14 receives the registration of information related to work processes. The work processes are obtained by breaking down the work into elements and defined based on the transition. The output unit 15 outputs a verification result regarding the work processes included in the work captured. The verification result is obtained based on learning in the learning unit 13. The memory 16 stores the verification result output from the output unit 15 in association with a video subjected to the verification.

The information processor 10 may be implemented by one or more computers. In other words, a computer program is executed on a computer to implement the operations of the gaze area registration unit 11, the object registration unit 12, the learning unit 13, the work process registration unit 14, and the output unit 15.

The operation of the information processor 10 will be described below.

The gaze area registration unit 11 receives a user input for registration of a gaze area. A user can register a gaze area by, for example, designating an area in a still image obtained by capturing the activity of work. The gaze area registration unit 11 registers the designated area as a gaze area based on the user input. The still image may be of any type. For example, the still image may be obtained from a video that captures the work. The information processor 10 may be provided with, as a function thereof, a user interface necessary for registering gaze areas, objects (described later), and information related to work processes (described later).

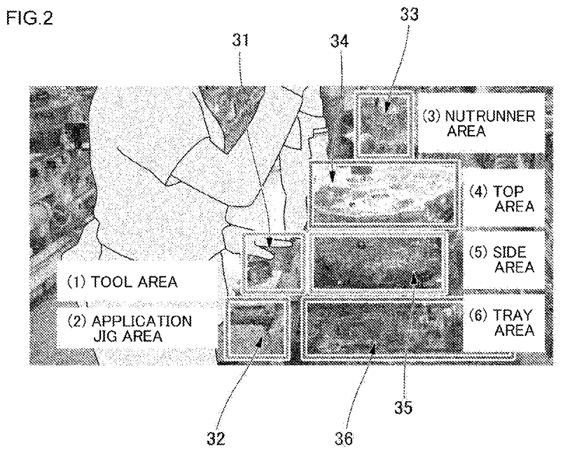

FIG. 2 is an example of a still image for receiving the registration of a gaze area.

In the example of FIG. 2, rectangular areas are designated as gaze areas in a still image. The gaze areas include: (1) tool area 31, (2) application jig area 32, (3) nutrunner area 33, (4) top area 34, (5) side area 35, and (6) tray area 36. Those selected as the gaze areas may be areas where an object such as a tool used in the work, a part (component), or a worker's hand comes in and out, and the progress of the work can be determined.

For example, a gaze area can be registered by specifying the name of the area (e.g., “tool area”), the location and shape (size) of the rectangle, and the display color for the area (color of the frame of the rectangle) on an uploaded still image such as the one illustrated in FIG. 2.

Next, the object registration unit 12 receives the registration of an object used for the work.

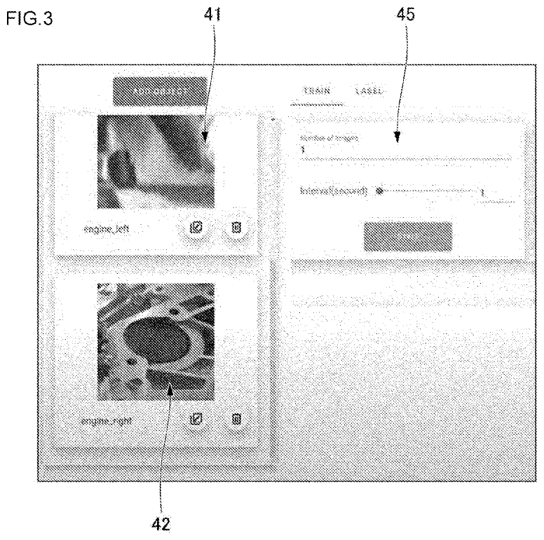

FIG. 3 is an example of a registration screen for receiving the registration of an object.

FIG. 3 illustrates an example in which objects necessary to determine the progress of the work are registered, and an annotation (creation of a training image) is performed so that each of the objects can be accurately recognized by learning in the learning unit 13. For example, the user creates a plurality of (e.g., 50 or more) training images using still images 41 and 42 obtained by capturing a video. The term “object” as used herein refers to an object that comes in and out of gaze areas registered as the work progresses. Examples of the object may include tools used in the work, parts or components, and workers' hands. In the registration of the hands of a worker, the left hand and the right hand may be registered separately or distinctively from each other. In addition, when an annotation is performed for the hands of a plurality of workers, the hands can be recognized regardless of the workers that the hands belong to. A worker's hand may be registered so as to be recognized with a predetermined glove on, depending on the actual work conditions.

In the registration of objects, the name of each object associated with a training image is registered according to a user's input operation on a registration area 45. Then, each object that appears in the video of the work is associated with the name so as to be recognizable through learning in the learning unit 13.

The number of training images may be set to a number that ensures the sufficient accuracy of learning in the learning unit 13. If the accuracy of learning in the learning unit 13 is found to be insufficient when checked, training images can be added and subjected to additional learning in the learning unit 13.

After that, the user performs an operation to cause the learning unit 13 to learn a ground-truth video as training images.

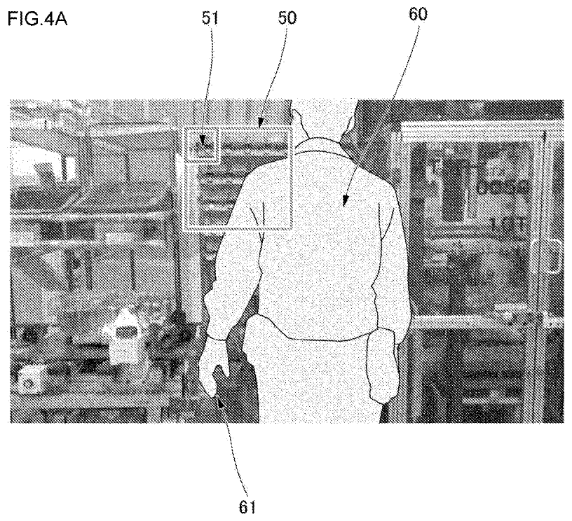

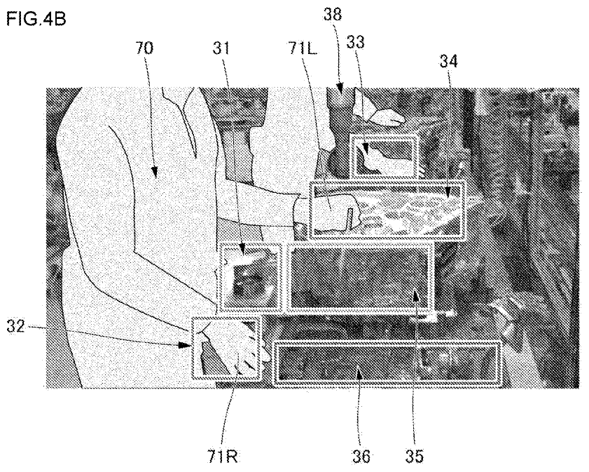

FIG. 4A is an example of a ground-truth video.

In the ground-truth video illustrated in FIG. 4A, there are set a storage area 50 in which shims (spacers) are stored and a correct area 51 corresponding to part of the storage area 50.

It is assumed, for example, that if the correct operation is performed in taking out a shim, a left hand 61 of a worker 60 extends into the storage area 50 (transition step 1), the left hand 61 then comes in the correct area 51 (transition step 2), and thereafter the left hand 61 comes out of the storage area 50 (transition step 3). In this case, the learning unit 13 learns the above transitions (transition steps 1 to 3) through the learning or recognition of one or more ground-truth videos as training images.

FIG. 4B is another example of a ground-truth video.

In the example of FIG. 4B, the ground-truth video contains three work processes (first to third work processes) obtained by breaking down a work (oil seal assembly) into elements.

The first work process is the process of applying a lubricant (insertion aid). In the first work process, first, a left hand 71L of a worker 70 enters the area 34, i.e., the top area denoted by (4) in FIG. 2 (transition step 11). Next, a right hand 71R of the worker 70 enters the area 35, i.e., the side area denoted by (5) in FIG. 2 (transition step 12). The right hand 71R then enters the area 32, i.e., the application jig area denoted by (2) in FIG. 2 (transition step 13). After that, the right hand 71R enters the area 36, i.e., the tray area denoted by (6) in FIG. 2 (transition step 14).

The second work process is the process of setting a nutrunner 38 (FIG. 4B). In the second work process, first, the right hand 71R of the worker 70 enters the area 33, i.e., the nutrunner area denoted by (3) in FIG. 2 (transition step 21). Next, the nutrunner 38 enters the area 35, i.e., the side area denoted by (5) in FIG. 2 (transition step 22). Then, the left hand 71L enters the area 31, i.e., the tool area denoted by (1) in FIG. 2 (transition step 23).

The third work process is the process of press-fitting with the nutrunner 38. In the third work process, first, the left hand 71L of the worker 70 enters the area 31, i.e., the tool area denoted by (1) in FIG. 2 (transition step 31). Next, the left hand 71L enters the area 31, i.e., the tool area denoted by (1) in FIG. 2 (transition step 32). Then, the nutrunner 38 enters the area 33, i.e., the nutrunner area denoted by (3) in FIG. 2 (transition step 33).

The user also performs an operation to cause the learning unit 13 to learn an error video as training images. The error video is a video that captures work activity where an error occurs. The learning unit 13 learns the entry and exit of objects in and out of the gaze areas and the order thereof in the error video as in the ground-truth video. The error video may include a video of work activity that is not erroneous in terms of work procedures but contains a dangerous condition or a condition that leads to danger. In this case, for example, a dangerous condition (near miss accident) in the production line can be detected and notified by the output unit 15.

As described above, through the learning of a ground-truth video, the learning unit 13 can learn the correct procedure of work in association with the order in which objects enter and exit gaze areas. In addition, the learning unit 13 can also learn an erroneous procedure of the work based on an error video.

Described below is a procedure for registering information on work processes in the work process registration unit 14.

As described in connection with FIG. 4B, when a work includes three work processes (first to third work processes) the user can register each of the work processes in association with transition steps shown in the ground-truth video. In the example of FIG. 4B, the first work process is registered in association with, for example, a period in which its state transits from transition step 11 to transition step 14. Similarly, the second work process is registered in association with, for example, a period in which its state transits from transition step 21 to transition step 23. The third work process is registered in association with, for example, a period in which its state transits from transition step 31 to transition step 33.

Such a state transition of a work process can be expressed and defined by a flowchart or the like.

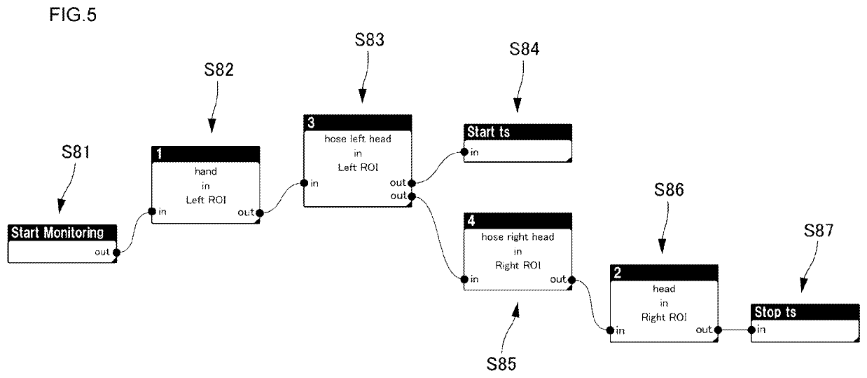

FIG. 5 is an example of a flowchart that defines a state transition of a work process.

The flowchart of FIG. 5 illustrates as an example the chronological relationship of transition steps S81 to S87 in a work process. For example, in FIG. 5, work is started in transition step S81, which is followed by a transition through transition step S82 to transition step S83.

The learning unit 13 learns such a state transition of a registered work process in association with a ground-truth video.

Next, the operation of the information processor 10 will be further described in relation to the operation of the output unit 15.

The information processor 10 receives an input of a video that captures actual work being performed. The video may be taken in real time, or it may have been taken and stored in the past.

The information processor 10 verifies work processes in the captured work based on the learning of a ground-truth video and an error video in the learning unit 13.

The verification regarding work processes involves the measurement of work time (cycle time). In the example of FIG. 4B, the work time to be measured includes the time spent on the work and the time taken per each of the three work processes (first to third work processes) included in the work. Such time measurement enables the work time to be figured out accurately without requiring human labor. In addition, verifying the video in real time allows the real-time analysis of individual workers' work. As a result, for example, an error in the work can be automatically detected in real time, which prevents defective products from being produced and immediately improves production efficiency.

The verification regarding work processes includes verifying whether work processes necessary for the work are performed. For example, when a work includes three work processes (first to third work processes) as illustrated in FIG. 4B, the information processor 10 verifies whether all the first to third work processes are performed (whether the video contains all the first to third work processes). If any one of the first to third work processes is not performed, the output unit 15 outputs an error indication as a verification result. This makes it possible to reliably detect a skipped step in work and the wrong placement (misplacement) of a tool or a part.

The verification regarding work processes also includes verifying the order of the work processes. For example, when a work includes a first work process, a second work process, and a third work process, which need to be performed in this order, the information processor 10 verifies whether these work processes are performed in the correct order. If the work processes are performed in the wrong order, the output unit 15 outputs an error indication as a verification result. Thereby, it is possible to reliably detect an error in the order of work processes.

If there is flexibility in the order of work processes, the learning unit 13 learns about it, and the information processor 10 reflects it in its verification result. For example, assuming that the work can be accomplished even if the second work process and the third work process are performed in the reverse order, the output unit 15 outputs a normal indication as a verification result when the order of these work processes is reversed in the captured work. In this case, the learning unit 13 may learn two ground-truth videos in which the order of the two work processes is opposite to each other. Alternatively, the learning unit 13 may learn a plurality of orders that are determined to be correct as the order of the work processes (first and second work processes) as illustrated in the example of FIG. 4B.

The verification regarding work processes may also include verifying whether there is added extra work. In this case, the output unit 15 may output an error indication as a verification result when an unnecessary object comes in and out of a gaze area.

The verification regarding work processes further includes verifying the order of steps of a state transition in each of the work processes. For example, the information processor 10 verifies whether the state transits in the same manner as in the flowchart of FIG. 5 (transition step S81→transition step S82→transition step S83→transition step S85→transition step S86→transition step S87). If there is an error in the order of the transition steps, the output unit 15 outputs an error indication as a verification result. This makes it possible to reliably detect an error in the order of steps in work processes.

As with the order of work processes, if there is flexibility in the order of steps of a state transition in a work process, the learning unit 13 learns about it, and the information processor 10 reflects it in its verification result. For example, assuming that the work can be accomplished even if the order of transition steps S82 and S83 in FIG. 5 is reversed, the output unit 15 outputs a normal indication as a verification result when the order of these transition steps is reversed in a captured work process. In this case, the learning unit 13 may learn two ground-truth videos in which the order of the two transition steps is opposite to each other. Alternatively, the learning unit 13 may learn a plurality of orders that are determined to be correct as the order of the transition steps as illustrated in the example of FIG. 5.

As described above, according to the embodiment, the information processor 10 performs the verification based on learning in the learning unit 13 focusing on the entry and exit of objects in and out of gaze areas. Therefore, even if a worker who appears in a video to be verified is different from the one in a ground-truth video, the output unit 15 outputs a normal indication as a verification result as long as the objects enter and exit the gaze areas in the same order as shown in the ground-truth video. In other words, erroneous error detection does not occur even if different workers are involved.

Note that the ground-truth video may include a plurality of videos that capture different workers. In this case, there may be a difference depending on workers in, for example, objects that enter and exit gaze areas in individual videos (e.g., a difference caused by whether each worker is left-handed or right-handed), the timing of the entry and exit of the objects, and the like; however, such a difference can be allowed or tolerated. Thereby, erroneous error detection can be effectively prevented.

While work verification is performed based on the entry and exit of objects in and out of gaze areas in the above embodiment, it is not so limited. In addition to or instead of the entry and exit of objects in and out of gaze areas, work verification may be performed based on the state of the objects in the gaze areas. The state of the objects may include, for example, the shape and movement of a worker's hand, the position and orientation of a tool or a part, and the movement of a tool or a part, such as the direction of movement, the direction of rotation, the speed of movement, and the speed of rotation.

If work involves a process of attaching a specified number of the same parts, it may be verified whether or not the number of times the process has been performed reaches the specified number by counting the process in association with transition steps as described above.

In the information processor 10 of the embodiment, a result of verification output from the output unit 15 is stored in the memory 16 in association with a video subjected to the verification. Therefore, data stored in the memory 16 can be used as a work history. The work history can be used to train workers and improve the quality of training. Thus, it is possible to achieve, for example, quantitative evaluation based on work time, the reduction of training time for new workers, and the improvement of training efficiency.

The work history can also be used to improve process efficiency. For example, it is possible to identify bottlenecks in work procedures and reduce production time. In addition, the cause of a defect can be identified in a short time.

The data stored in the memory 16 may be assigned a worker ID so that it can be managed with respect to each worker. The worker ID also makes it possible to use the data stored in the memory 16 for work management with respect to each worker, in cooperation with the system on the line side. In this case, for example, the margin of work hours can be evaluated for each worker by managing the waiting time of each worker in the system on the line side. As a result, work processes on the line can be optimized.

As described above, according to the embodiment, the information processor 10 verifies a video that captures work based on learning in the learning unit 13 and outputs a verification result. With this, it is possible to reliably detect an error in the work such as a skipped step, the wrong order of procedures, and the misplacement of a tool or a part. Additionally, the time required for the work can be figured out accurately without relying on human labor.

Furthermore, through learning based on gaze areas and objects related to the work, the learning unit 13 can efficiently learn various errors in the work, which greatly reduces the burden on the user required for the learning. In addition, errors can be detected efficiently by verification based on the gaze areas and the objects.

While preferred embodiments of the invention have been described and illustrated, it is to be understood that the invention is not limited to the embodiments disclosed herein. Various changes, modifications, and alterations may be made within the scope of the invention as defined in the appended claims. Furthermore, all or some of the constituent elements described in the above embodiments may be variously combined.

1. An information processor, comprising:
processing circuitry configured to
receive registration of a gaze area,
receive registration of an object used in work,
perform learning of a transition in presence or absence of the object in the gaze area or a transition in a state of the object according to progress of the work based on a training image that contains the object, and
receive registration of information related to work processes, which are obtained by breaking down the work into elements and defined based on the transition; and
an output unit that outputs a verification result regarding the work processes included in the work captured, wherein the verification result is obtained based on the learning.

2. The information processor according to claim 1, wherein the object is a tool used in the work, a part, or a worker's hand.

3. The information processor according to claim 1, wherein the output unit outputs an amount of time required for the work processes as the verification result.

4. The information processor according to claim 1, wherein the output unit outputs whether each of the work processes is performed or whether there is an error in the work processes as the verification result.

5. The information processor according to claim 2, wherein
the processing circuitry is further configured to receive registration of order information indicating an order of the work processes, and
the output unit outputs, as the verification result, whether the work processes included in the work captured are performed in the order indicated by the order information.

6. A computer program product comprising a non-transitory computer-usable medium having a computer-readable program code embodied therein, the computer-readable program code, when executed on a computer, causing the computer to:
receive registration of a gaze area;
receive registration of an object used in work;
perform learning of a transition in presence or absence of the object in the gaze area or a transition in a state of the object according to progress of the work based on a training image that contains the object;
receive registration of information related to work processes, which are obtained by breaking down the work into elements and defined based on the transition; and
output a verification result regarding the work processes included in the work captured, wherein the verification result is obtained based on the learning.
